(19) United States
(12) Patent Application Publication
(10) Pub. No.: US 2014/0013202 A1
(43) Pub. Date: Jan. 9, 2014

(54) WEB PAGE DISPLAY SYSTEM

(71) Applicant: VIDEODESK, Paris (FR)

(72) Inventor: Igor SCHLUMBERGER, Paris (FR)

(73) Assignee: VIDEODESK, Paris (FR)

(21) Appl. No.: 13/685,886

(22) Filed: Nov. 27, 2012

(30) Foreign Application Priority Data
Jul. 3, 2012 (FR) 1201876

(51) Int. Cl. G06F 17/22

(52) U.S. Cl. CPC G06F 17/2247; G06Q 30/0601
USPC 715/234

(57) ABSTRACT

A system for displaying a web page in which a server 1 stores content data 101 and definition data 102 of a web page. A first device 3 transmits availability data. A second device 5 sends a request to the server 1 and receives in response the web page data. The server 1, in response to the receipt of the availability data from the first device 3, determines the update data for the web page. The update data include data to link the first device 3 and the second device 5. The server 1 sends the update data to the second device 5 to adapt the content of the web page independently of any request to refresh the definition data 102 associated with the web page displayed by the second device 5.

The present invention concerns the setting up of a communication between two users linked by a network. More specifically, it concerns a web page display system and method for a communication of this type.

Recent developments in communication means and in online payment methods have made it possible for new trading methods to appear and be used. Although each type of trading has its own characteristics, the majority are seeing a growing share of transactions made over the Internet. Certain recent ventures are even basing their economic model on dematerialised systems and are dispensing with physical points of sale. This dematerialisation offers many advantages, notably financial. This change of context is accompanied also by a great change in the interactions between the sellers or service providers and the clientele.

The Applicant has studied the factors leading to the execution of the buy by the consumer. In a traditional context, that is, with seller and buyer face to face, the human qualities of the seller are crucial. In particular, the body language, the voice intonations, facial expressions, etc., form part of the communication. The Applicant has determined that this dimension is scarcely present in so-called “electronic” or “online” trade. In fact, the information and advice before the purchase are as virtual as the purchase itself. However, these items are difficult to find and the need for a human contact is being felt in online purchases. From the consumer's point of view, the difficulty in obtaining personalised advice from a human contact becomes a constraint in the purchasing act. The current means of telecommunication exclude the human aspect of advice by the sellers and thus deprive enterprises of the value added by the individuals representing them.

At the beginnings of online trading, the Internet sites relied on impulse decisions of online consumers. This type of buying has evolved. The consumers of today are educated and are no longer fooled by online commercial practices. From now on, the customer relationship and confidence building have become crucial.

The ease and speed with which a consumer is able to compare and assess the competition in a virtual context make the faults described above all the more disadvantageous. For example, a potential buyer with the choice between two stores offering the same product under the same conditions will tend to veer towards the one which seems the better in answering his questions. Responses and advice which are both rapid and personalised will be decisive advantages in this sense. By contrast, having to wait, even for a few minutes, is enough to lose the consumer's attention. This “acceptable waiting time”, though hard to quantify, still remains more of a constraint over the Internet than for a physical shop.

The consumer, therefore, wants to benefit from the advantageous practical and financial conditions associated with the dematerialisation of the sales means (purchasing from one's home, economising on costs associated with physical shops, . . . ), while still continuing to enjoy the human interactions between seller and buyer. The current systems fail to satisfy this aspect.

On Internet sites run by sellers and services suppliers, services exist which enable questions to be asked by sending messages working more or less like electronic mail. The responses, information and arguments are only supplied by the seller to the potential buyer after a long delay. If the buyer wants to know how long he must wait for the answer to one of his questions, he has to make do with a promise to react from the seller, such as in the form of an automatic response like “an advisor will answer you as quickly as possible”.

Certain Internet sites offer to contact the buyer by telephone. This involves the buyer supplying his telephone number. Furthermore, the actual availability and reactivity of the seller is not known by the potential buyer at this step. Here again, the inconvenience is prohibitive.

On other Internet sites, the buyer is directed towards forums or FAQs. This involves effort on the part of the buyer, who may well devote his energy to looking for a more reactive competitor.

Other systems again offer to answer the buyer's questions directly through an automatic system programmed for these operations. This amounts to “virtual assistance”. This type of seller-buyer relationship is dehumanised and often barely effective.

Finally, some of the methods described are accessible only after the buyer has registered in the data processing systems linked to the Internet site. The buyer may be put off by the idea of providing personal details. Rapid matching of the supplier of a service and a “casual” buyer is impossible. And the development of customer loyalty with this not-yet faithful clientele is generally the most difficult. Casual buyers are often those who spend the least time and energy on their purchasing actions.

No existing system is able to satisfactorily put together speed, availability and human interaction in the contact matching of a future buyer with a seller.

The invention is intended to improve the situation.

Firstly, a web page display system is proposed. The system comprises:
a server storing content data and definition data for a web page,
at least one first device comprising communication means suitable for communicating with the server, the first device being arranged to send availability data to the server, and
at least one second device comprising communication means suitable for communicating with the server, the second device being arranged to send a request to the server and to receive in response web page data derived from the content data and definition data of the web page.

The server is also arranged, in response to receiving availability data from the first device, to determine update data from the availability data received from the first device. The update data comprise data to link the first device and the second device. The server is also arranged to send the update data to the second device to adapt the contents of the page derived from the content data and displayed by the second device, independently of any request to refresh the definition data associated with the web page displayed by the second device.

Moreover, the system can have the following characteristics, singly or in combination:
The server is arranged to determine initiation command data for a video and/or audio communication between the first and second devices based on the availability data. The server is arranged to include the initiation command data in the data to link the first device and the second device.
The server is arranged to determine the initiation command data for a video and/or audio communication between the first and second devices. The server is arranged to include the initiation command data with the web page definition data. The server is arranged to determine the parameters defining the activity of the initiation command from the availability data and to include said parameters in the data to link the first device and the second device.
The content data comprise static content data and dynamic content data. The web page data comprise static content data. The update data comprise dynamic content data. The server is arranged to determine update data from the availability data received from the first device. The server is arranged to adapt the content of the web page derived from the dynamic content data and displayed by the second device.
The web page data sent in response to the request are derived from the content data independently from the dynamic content data.
The update data are derived only from the dynamic content data.
The web page data comprise code, the execution of which by the second device prompts the transmission of secondary requests to the server, distinct from the initial request, in a recurrent fashion and/or based on the activity of the user of the second device on the web page. In response, the secondary requests prompt the transmission of update data by the server.
The transmission of update data to the second device by the server is independent of any request by the second device.
The definition data for the web page are in Ajax language.
The data to link the first and second devices involve the initiation of a communication in a Flash environment between the first and second devices.

A method for displaying a web page is also proposed involving a server storing content data and web page definition data, at least one first device comprising communication means suitable for communicating with the server, and at least one second device comprising communication means suitable for communicating with the server. The method comprises the following steps:

a. Sending from the second device a request to the server,

b. Receiving in response web page data derived from content data and definition data defining the web page,

c. Sending from the first device to the server availability data for the first device.

The method also comprises the following steps:

d. Determining update data from the availability data from the first device, said update data comprising data to link the first and second devices,

e. Sending from the server to the second device the update data,

f. Adapting the web page content derived from the content data and displayed by the second device, independently of any request to refresh the definition data associated with the web page displayed by the second device.

The present invention will be better understood by studying the detailed description of some embodiments used as, but not limited to, examples, and illustrated by the attached drawings, on which:

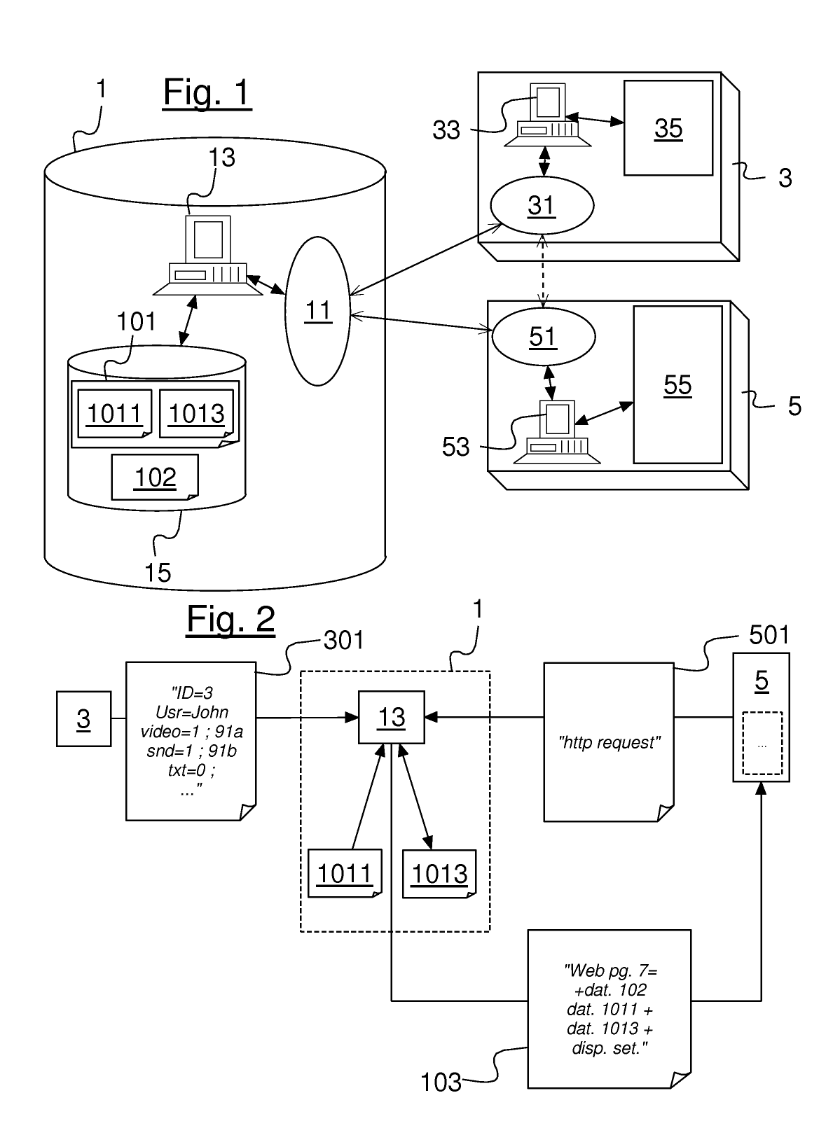

FIG. 1 is a diagrammatic view of devices implementing the system according to the invention;

FIG. 2 is a functional diagram of a first step implemented by the system of FIG. 1;

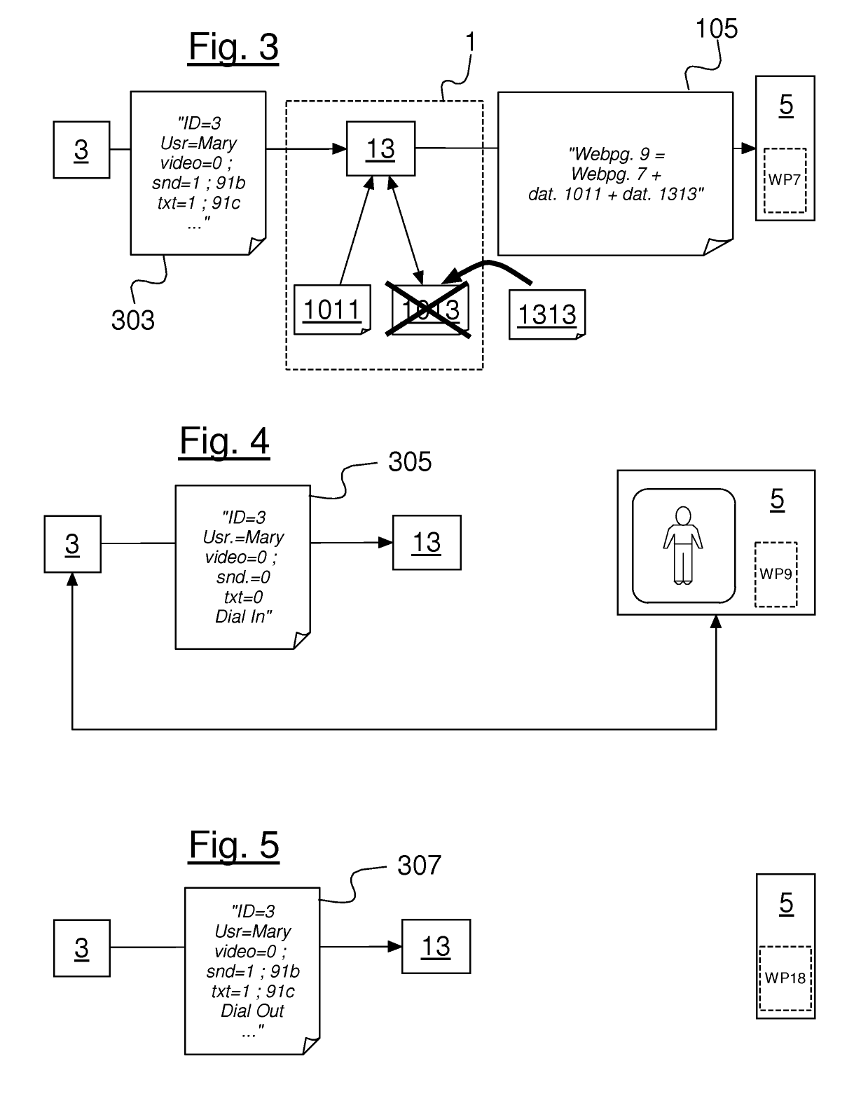

FIG. 3 is a functional diagram of a second step implemented by the system of FIG. 1;

FIG. 4 is a functional diagram of a third step implemented by the system of FIG. 1;

FIG. 5 is a functional diagram of a fourth step implemented by the system of FIG. 1.

The attached drawings comprise certain characteristic elements. They will therefore not only serve to complete the invention, but also to contribute to its definition if necessary.

In the embodiment represented in FIG. 1, the system comprises a server 1, a first device 3 and a second device 5. Hereinafter, the terms “first device” and “second device” are used to differentiate the two objects functionally. The first device 3 and the second device 5 may be structurally similar or different. Also, in order to avoid making the description and the figures unnecessarily cumbersome, the system presented here comprises one unique first device 3 and only one second device 5. In practice, the system is intended to allow the interaction of a multiplicity of first devices and a multiplicity of second devices.

The server 1 comprises communication means 11, a processor 13 and a database 15. The processor 13 controls the communication means 11 and can access the database 15. The database 15 stores content data 101 and definition data 102 of web pages which together define a web page 7. The content data 101 comprise static content data 1011 and variable content data 1013 which are described in more detail below. The first device 3 and the second device 5 each comprise communication means 31 and 51 respectively, a processor 33 and 53 respectively and a user interface 35 and 55 respectively. The first device 3 and the second device 5 may be computers, smartphones, tablets, interactive terminals available to the public, for example in a shop, or any other device which can be connected to the Internet.

In the example described here, the first device 3 and the second device 5 each comprise peripherals. Here, the peripherals comprise a screen, a keyboard, a microphone, a camera and a speaker. For greater clarity, the peripherals are not represented in the figures. As an alternative, the first device 3 and/or the second device 5 lack at least some of these peripherals and/or comprise other functionally similar peripherals such as a touch screen.

The communication means 11, 31, 51 comprise, in the example described here, a modem arranged for linking respectively the server 1, the first device 3 and the second device 5 to the Internet. As an alternative, the communication means 11, 31, 51 comprise wireless telephony, i.e. compatible GSM, GPRS, EDGE, 3G or LTE, wired telecommunication means, “wifi” wireless communication means, satellite based communication means, or even a combination of these means.

The processor 33 of the first device 3 is arranged to define information on the availability of modes of communication. By way of, but not limited to such an example, this might be: electronic messaging, instantaneous messaging, voice conversation, a video, voice or video messaging and a combination of the above means such as a video conference combining voice and video conversation and possibly graphic documents. In other words, the processor 33 attributes to each mode of communication an “available” or “unavailable” Boolean value. As an alternative, the value can be non Boolean, for example encoded on a byte so as to indicate more than two states.

Here, the processor 33 is arranged to define by default the availability modes based on the peripherals of the first device 3. For example, the processor 33 of the first device 3 is arranged to automatically parameterise the “video conference” mode as “available” in response to detecting that a camera and a microphone are in working condition. The availability of the modes of communication, i.e. the value attributed to each mode of communication, may further be modified manually by the user of the first device 3 and by means of the user interface 35. For example, even if the camera and the microphone of the first device 3 are in working condition, the user of first device 3 may decide to be unavailable for a video conference type of communication. Then the processor 33 modifies the parameterisation of the available modes of communication as a result.

The availability of modes of communication may also be controlled from a machine other than the first device 3 which is connected to it, independently of the link with the server 1. For example, a group of first devices 3 can be controlled centrally by a single machine called the “master”. This type of operation is particularly useful in the context of a commercial platform grouping together users who each have a first device 3.

As shown in FIG. 2, the first device 3 is arranged to send availability data 301 to the server 1. The first device 3 transmits the availability data 301 through the communication means 31 and the communication means 11 of the server 1. In the example described here, the availability data 301 comprise an identifier of the first device 3, an identifier of the user of the first device 3 and information about the modes of communication available for the first device 3, the latter being derived from the parameterisation carried out by the processor 33. The availability data 301 also comprise, for each mode of communication parameterised as “available”, data allowing the server 1 to determine, from the availability data 301, associated initiation command data 91a, 91b, 91c . . . . The initiation command data 91 are described in more detail below.

When the server 1 receives the availability data 301 from the first device 3, said server updates a part of the content data 101 defining the web page 7 in the database 15. The content data 101 defining the web page 7 comprise the latest information derived from the availability data 301 received from the first device 3. The content data 101 defining the web page 7 comprise the static content data 1011 and the dynamic content data 1013. In the example herein described, the server 1 updates at least a part of the dynamic content data 1013 in the database 15. The server 1 leaves the static content data 1011 unchanged. In the example herein described, the static content data 1011 and the dynamic content data 1013 are stored in the same database 15. As an alternative, the static content data 1011 and the dynamic content data 1013 may be stored in two distinct locations in two distinct physical media and/or several distinct databases.

The second device 5 is arranged to send a request 501 to the server 1. The request 501 is, in the example herein described, a request of the “hypertext transfer protocol” (http) type. The second device 5 then assumes the role of a client (in the IT meaning of the term) requesting a web page 7 from the server 1. The web page 7 is a combination of static content data 1011 and dynamic content data 1013, arranged based on the definition data 102. In response, the server 1 sends to the second device 5 the web page data 103 derived from the content data 101 and the definition data 102 of the web page 7. The data of web page 103 here comprise at least a part of the static content data 1011 and at least a part of the dynamic content data 1013. The display on the screen of the second device 5 is produced, based on the static content data 1011 and of the dynamic content data 1013 defining the content of the web page 7, by the processor 53.

At this stage, the second device 5 is connected to the server 1 and the second device 5 is displaying the web page 7 on its screen. The web page 7 thus displayed comprises information derived from the content data 101 defining the web page 7, which themselves include dynamic content data 1013 derived from the availability data 301 transmitted from the first device(s) 3 to the server 1. The user of the second device 5 thus receives, amongst other things, the latest availability information transmitted from the first device 3 to the server 1.

As an alternative, the web page data 103 are devoid of the dynamic content data 1013. The display on the screen of the second device 5 is produced based on the static content data 1011 by the processor 33. The data of web page 103 sent in response to the request 501 are derived from the content data 101 independently of the dynamic content data 1013. The user of the second device 5 thus receives, amongst other things, the information derived from the static content data 1011. The information contained in the dynamic content data 1013 are visible only after receipt of a response to a specific request or after receipt of update data.

When the first device 3 changes “status”, i.e. its availability parameters are changed, the available/unavailable value of at least one of the modes of communication is modified. The processor 33 performs a new parameterisation, i.e. it defines new availability information about the modes of communication. This situation is represented in the left part of FIG. 3. The first device 3 is arranged to send new availability data 303 to the server 1.

In the example herein described, the availability data 303 comprise an identifier of the first device 3, an identifier of the user of the first device 3 and new availability data of the modes of communication of the first device 3, the latter being derived from the most recent parameterisation performed by the processor 33. The new availability data 303 comprise, for each mode of communication parameterised as “available”, associated initiation command data 91d, 91e, 91f . . . .

The information of the modes of communication comprise, in the example herein described, the entirety of the availability data of the first device 3, i.e. essentially the same amount of information as in the initial availability data 301 but with parameters modified based on the latest events. As an alternative, only the information modified with respect to the first transmission are included in the new availability data 303, so as to restrict the amount of data to be sent.

The first device 3 transmits the new availability data 303 through the communication means 31 and communication means 11 of the server 1.

The server 1 is arranged, in response to receiving the new availability data 303 of the first device 3, to update the dynamic content data 1013 into new dynamic content data 1313 in the database 15. The new dynamic content data 1313 allow an updated web page 9 to be defined. The updated web page 9 thus corresponds to a combination of the unchanged static content data 1011 and the new dynamic content data 1313 derived from new availability data 303 received from the first device 3. At this stage, an additional second device sending a request 501 to the server 1 would obtain, in response, data defining the updated web page 9.

As represented in the right part of FIG. 3, the server 1 sends update data 105 to the second device 5 after the update of the database 15. The update data 105 are intended to adapt the contents of the web page 7 derived from the content data 101 and displayed by the second device 5. As an alternative, the server 1 sends update data 105 to the second device 5 independently of the updating of the database 15.

In one embodiment in which a multiplicity of first devices 3 is connected to the server 1, each new transmission of availability data 303 by one of the first devices 3 to the server 1 generates the transmission of update data 105 from the server 1. The update data 105 comprise new dynamic content data 1313. The transmission of the update data 105 is carried out to each second device 5 displaying the contents of the web page 7 such that the content of the web page 7 derived from the content data 101 is adapted and displayed by the second device 5 in order to allow the display of the content of the modified web page 9.

According to a first embodiment, the web page is written in asynchronous language or “Asynchronous Javascript and XML”, also designated by the term Ajax. The architecture of the web page 7, 9 is defined in the definition data 102 of the web page 7, 9. The static content data 1011 of the web page 7, 9 comprise a code which is executed by the processor 55 of the second device 5. The computer program here is written in Javascript. The execution of the computer program prompts the recurrent transmission by the processor 55 to the server 1 of secondary requests, distinct from the initial request 501. The transmission of secondary requests may depend also on the actions of the user of the second device 5 on the web page, such as running the mouse pointer over an object (an event known as an “onmouseover”). These secondary requests prompt, in response, the transmission from the server 1 of update data 105 comprising a part or all of the new dynamic content data 1313, for example, in XML format. As an alternative, the initial request 501 prompts the transmission of static content data 1011 (containing the code) while the initial dynamic content data 1013 are transmitted only in response to a secondary request prompted by the execution of the code. This allows the display of the web page 7 to be accelerated.

According to a second embodiment, the transmission of update data 105 by the server 1 to the second device 5 is independent of any request to refresh the web page 7 from the second device 5. A connection is kept open between the server 1 and the second devices 5. The transmission of update data 105 is also independent of any secondary request prompted by the execution of a code from the second device 5. In other words, whether or not the second device 5 displaying the web page 7 sends a new request to the server 1 to obtain the latest updates of the web page 7 has no influence over the transmission of update data 105 by the server 1 to the second device 5. Except for the first request 501, the transmission of secondary requests manually or automatically from the second device 5 is unnecessary. The operation is triggered by the server 1 and not by the second device 5. The second embodiment can be implemented in the way of web applications known as “Comet”, such as Ajax Push Engine or “APE”.

In each of the embodiments, the web page 7 is called “dynamic”. From the point of view of the user of the second device 5, the display of the web page 7 is updated without the need for action on his part and, in particular, without this user requesting the complete refreshing of the web page by means of his Internet browser.

The second device 5 adapts the display of the web page 7 into a modified web page 9 based on the update data 105 and the new dynamic content data 1313. The processor 55 of the second device 5 does not modify the display of the static content data 1011 on the screen and simply updates the display based on the dynamic content data 1013, 1313. The display of the dynamic content data 1013 is modified in a display of the new dynamic content data 1313. Here, the modified web page 9 corresponds to the initial web page 7 in which the information relating to the availability of the first device 3 has been updated and modified, based on the new dynamic content data 1313.

In the example described here, the availability data 301, 303 comprise, for each mode of communication parameterised as “available”, associated initiation command data 91a, 91b, 91c. As a result, the second device 5 receives, for each available mode of communication, respective initiation command data 91. The initiation command data 91 allows the selective triggering of each type of communication between the first device 3 and the second device 5. A video communication, for example, is triggered by the initiation command data 91a and an audio communication is triggered by the initiation command data 91b. Each initiation command data 91a, 91b takes the form of a hypertext link or a clickable icon on the web page 7, 9 displayed on the screen of the second device 5. The second device 5 is capable of adapting the display based on the availability of the modes of communication. For example, the second device 5 can display a unique link or an icon combining the initiation command data 91a and the initiation command data 91b so that they correspond to an initiation command for a video conference, i.e. sound and vision at the same time.

The initiation commands 91 can open a communication interface directly on the web page 7, 9 (sound, vision, videos, texts . . . ) or by the opening of a new web page.

In one embodiment, the communication interface is set up in a “Flash” environment. The communication happens by means of the broadcast of a bidirectional flow between the first device 3 and the second device 5.

In the embodiments described, the initiation command data 91 derived from the availability data 301 are transmitted amongst update data 105 and thus form part of the dynamic content data 1013, 1313. As an alternative, the initiation command data 91 form part of the static content data 1011 of the web page 7 as stored initially in the database 15 of the server 1, and not of the availability data 301. In this case, the update data 105 comprise parameters derived from the availability data 301, 303 of the first device 3 and define the activation state of each initiation command 91. Said initiation commands 91 are activated or deactivated based on said parameters on the web page 7, 9 displayed on the second device 5. For example, if the availability of the first device 3 is parameterised in the update data 105 as “unavailable”, as far as audio or video conversations or video conferences are concerned, it is impossible for the user of the second device 5 to activate the initiation command 91a relating to the video or the initiation command 91b relating to the sound through the user interface 55. Furthermore, and in accordance with current standards, a non-clickable red or grey icon, or even the absence of an icon, can show that it is not possible to start up a video conference, whereas a clickable green icon allows the link-up process to be started. The link-up can be initiated by the user of the second device 5 with minimum action, for example by a single click.

If a direct link-up cannot be established, a command is available for a message to be left. In other words, in the event that the user of the first device 3 is unavailable immediately, the user of the second device 5 is offered the opportunity to leave a message. The message can be text, a voice message and/or a video message.

The “link-up data” can designate the initiation command data 91 such that the parameters define the state of activation of each of the initiation commands 91 or both. The availability data 301, 303 comprise the link-up data in the form of initiation command data 91, of parameters defining the state of activation of each of the initiation commands 91 or of a combination thereof.

From the point of view of the user of the second device 5, the possibility of establishing a connection with the first device 3 (video conference, voice conversation, instantaneous message, . . . ) is either immediately possible by the activation of a initiation command 91, or impossible. In the case of a multiplicity of first devices 3, the user of the second device 5 is in a position to identify and to select which first device 3 to contact amongst those available.

In the case of a commercial service platform comprising several telephone salespersons/call centre agents, each equipped with a first device 3, a consumer equipped with a second device 5 is in a position to select which call centre agent he wants to contact based on his availability as well as other criteria. This link is initiated by the consumer and made almost immediately. This operating mode differs notably from that of current commercial platforms in which the consumers are placed “on hold” for an undetermined time, then placed in communication with the first call centre agent available.

At the time that communication is established between a first device 3 and a second device 5, the first device 3 resends updated availability data 305 to the server 1. This operation is represented in FIG. 4. The new availability data 305 contain, for example, information of the type “communication in progress; unavailable”. These availability data 305 are treated by the server 1 in a similar manner to the other availability data 301, 303.

When the conversation stops new availability data 307 are sent by the first device 3 to the server 1 containing information of the type “end of communication; available”. This operation is represented in FIG. 5. These availability data 307 are treated by the server 1 in a similar manner to the other availability data 301, 303, 305.

The processor 13 of the server 1 can also be configured to archive, for example in the database 15 or in any type of memory, the requests of the second devices 5 on the one hand, and the availability data 301, 303, 305, 307 of the second devices 5 on the other. This allows, for example, general or targeted statistics to be gathered about the availability, modes of communication and popularity of the call centre agents. These statistics can be analysed subsequently to improve the seller-buyer relationship or, generally speaking, between supplier of services and consumer.

In the system described, the communication interface is achieved in a Flash environment. This interface can be achieved in another equivalent environment, for example through additional (plug-in) modules of the Internet browser. This allows the web surfer to dispense with a third-party or dedicated application. As an alternative, the communication is established through a web browser with Real-Time Communication means (“webRTC”). This dispenses with the need to install a browser module.

As an alternative, the system is dedicated to matching web surfers with competent and/or specialised persons. In this case, the web page displayed on the second devices 5 operates like a search engine or a portal. Thus, as well as the availability of each first device 3, the web surfer using a second device 5 can search then select his intermediary based on his capabilities and his displayed speciality fields.

Furthermore, implementation methods have been described in which the first device 3 sends update data through an action by its user. As an alternative, the emission of these data can be automatic or semi-automatic. For example, the first devices can comprise means to detect presence such as the detection of a face in front of the camera, the detection of movements or actions on the mouse or keyboard, etc. . . . Thus, in the absence of the detection of an actual presence for a predetermined period, the status “unavailable” can be triggered by the processor 33.

The accessibility to the system by a web surfer using a second device 5 may depend on parameters external to the system described above. On a shopping site, the trader may choose to reserve the service offered by the invention to his registered buyers, to his loyal buyers recognised by a “promotional code” or even to web surfers having preselected or already purchased certain items. For example, the service may be reserved for buyers whose “basket”, i.e. the items preselected and/or already purchased, exceed a threshold price.

In another example, the owner of the shopping site may personalise access to the system based on purchases and/or buyers. This identification/selection of the buyer based on his purchases can be combined with a search engine-type or a portal-type functioning mode. By identifying the buyer, the system can suggest “intelligently” a link-up with an intermediary specialising in that type of purchase (white goods installation, furniture assembly, DIY, etc.).

The invention is not limited to the examples of systems and methods described above, used only in the way of examples, but it encompasses all of the versions which an expert in the art could envisage within the context of the following claims.

1. Web page display system comprising:
a server (1) storing content data (101) and definition data (102) of a web page (7),
at least one first device (3) comprising communication means (31) suitable for communicating with the server (1), the first device (3) being arranged to send availability data (301, 303, 305, 307) to the server (1),
at least one second device (5) comprising communication means (51) suitable for communicating with the server (1), the second device (5) being arranged to send a request (501) to the server (1) and to receive in response web page data (103) derived from the content data (101) and the definition data (102) of the web page (7),
characterised in that
the server (1) is also arranged, in response to receiving the availability data (301, 303, 305, 307) from the first device (3), to determine update data (105) from the availability data (301, 303, 305, 307) received from the first device (3), said update data (105) comprising data to link the first device (3) and the second device (5), the server (1) being arranged to send the update data (105) to the second device (5) to adapt the contents of the page (7) derived from the content data (101) and displayed by the second device (5), independently of any request to refresh the definition data (102) associated with the web page (7) displayed by the second device (5).

2. System according to claim 1, wherein the server (1) is arranged to determine the initiation command data (91) for a video and/or audio communication between the first device (3) and second device (5) based on the availability data (301) and to include the initiation command data (91) in the data to link the first device (3) and the second device (5).

3. System according to claim 1, wherein the server (1) is arranged to determine the initiation command data (91) for a video and/or audio communication between the first device (3) and the second device (5), to include the initiation command data (91) in the definition data (102) of the web page (7), to determine the parameters defining the activity of the initiation command (91) from availability data (301) and to include said parameters in the data to link the first device (3) and the second device (5).

4. System according to claim 1, wherein the content data (101) comprise static content data (1011) and dynamic content data (1013), the web page data (103) comprising static content data (1011), the update data (105) comprising dynamic content data (1013), the server (1) being arranged to determine the update data (105) from availability data (301) received from the first device (3) to adapt the content of the web page (7) derived from the dynamic content data (1013) and displayed by the second device (5).

5. System according to claim 4, wherein the web page data (103) sent in response to the request (501) are derived from the content data (101) independently from the dynamic content data (1013).

6. System according to claim 4, wherein the update data (105) are derived only from the dynamic content data (1013).

7. System according to claim 1, wherein the web page data (103) comprise code, the execution of which by the second device (5) prompts the transmission of secondary requests to the server (1), distinct from the initial request (501), in a recurrent fashion and/or based on the activity of the user of the second device (5) on the web page (7), said secondary requests prompting in response the transmission of update data (105) by the server (1).

8. System according to claim 1, wherein the transmission of update data (105) to the second device (5) by the server (1) is independent of any request by the second device (5).

9. System according to claim 1, wherein the definition data (102) for the web page (7) are in the Ajax language.

10. System according to claim 1, wherein the data to link the first device (3) and the second device (5) involve the initiation of a communication in a Flash environment between the first device (3) and the second device (5).

11. Method for displaying a web page involving a server (1) storing content data (101) and definition data (102) for a web page (7), at least one first device (3) comprising communication means (31) suitable for communicating with the server (1), and at least one second device (5) comprising communication means (51) suitable for communicating with the server (1), said method comprising the following steps:
a. Sending from the second device (5) a request (501) to the server (1),
b. Receiving in response web page data (103) derived from content data (101) and definition data (102) defining the web page (7),
c. Sending from the first device (3) to the server (1) availability data (301) for the first device (3),
the method being characterised in that it also comprises the following steps:
d. Determining update data (105) from the availability data (301) received from the first device (3), said update data (105) comprising data to link the first device (3) and the second device (5),
e. Sending from the server (1) to the second device (5) the update data (105),
f. Adapting the content of the web page (7) derived from the content data (101) and displayed by the second device (5), independently of any request to refresh the definition data (102) associated with the web page (7) displayed by the second device (5).

12. System according to claim 2, wherein the content data (101) comprise static content data (1011) and dynamic content data (1013), the web page data (103) comprising static content data (1011), the update data (105) comprising dynamic content data (1013), the server (1) being arranged to determine the update data (105) from availability data (301) received from the first device (3) to adapt the content of the web page (7) derived from the dynamic content data (1013) and displayed by the second device (5).

13. System according to claim 3, wherein the content data (101) comprise static content data (1011) and dynamic content data (1013), the web page data (103) comprising static content data (1011), the update data (105) comprising dynamic content data (1013), the server (1) being arranged to determine the update data (105) from availability data (301) received from the first device (3) to adapt the content of the web page (7) derived from the dynamic content data (1013) and displayed by the second device (5).

14. System according to claim 5, wherein the update data (105) are derived only from the dynamic content data (1013).

15. System according to claim 2, wherein the web page data (103) comprise code, the execution of which by the second device (5) prompts the transmission of secondary requests to the server (1), distinct from the initial request (501), in a recurrent fashion and/or based on the activity of the user of the second device (5) on the web page (7), said secondary requests prompting in response the transmission of update data (105) by the server (1).

16. System according to claim 2, wherein the transmission of update data (105) to the second device (5) by the server (1) is independent of any request by the second device (5).
